(19) United States
(12) Patent Application Publication
(10) Pub. No.: US 2016/0280600 A1
(43) Pub. Date: Sep. 29, 2016

(54) POLYMER-MODIFIED FIBER-CEMENT COMPOSITION

(71) Applicant: E. I. DU PONT DE NEMOURS AND COMPANY, Wilmington, DE (US)

(72) Inventors: ALDO R. TAVAREZ, HOCKESSIN, DE (US); BENJAMIN ANDREW SMILLIE, KINGSTON (CA); TIMOTHY A. LIBERT, HOCKESSIN, DE (US); RICHARD ALLEN HAYES, BEAUMONT, TX (US); MARK R. ROHDE, WILMINGTON, DE (US)

(21) Appl. No.: 15/078,350

(22) Filed: Mar. 23, 2016

Related U.S. Application Data
(60) Provisional application No. 62/136,771, filed on Mar. 23, 2015.

(51) Int. Cl. C04B 24/26

(52) U.S. Cl. CPC C04B 24/2641

(57) ABSTRACT

A method for providing a polymer-modified fiber-cement composite by forming an aqueous composition including admixing an aqueous dispersion comprising a water dispersible ionomer and an ethylene elastomer, an ethylene dicarboxyl copolymer, an ethylene ester copolymer or a grafted copolymer, cement, cellulosic fibers, siliceous material, and water; forming a composite precursor by removal of at least some of the water; and curing/drying the composite precursor at a temperature at least 10° C. higher than the Tg of the polymer is provided. Polymer-modified fiber-cement composites formed by the method and articles therefrom are also provided.

### CROSS-REFERENCE TO RELATED APPLICATION

This application claims priority under 35 U.S.C. §119 to U.S. Provisional Appln. No. 62/136,771, filed on Mar. 23, 2015, which is incorporated herein by reference in its entirety.

### FIELD OF THE INVENTION

This invention relates to a polymer-modified fiber-cement composite and a method to prepare the composite.

### BACKGROUND OF THE INVENTION

Several patents and publications are cited in this description in order to more fully describe the state of the art to which this invention pertains. The entire disclosure of each of these patents and publications is incorporated by reference herein.

Portland cement and other inorganic cements are combined with different aggregates and/or fibers to produce a wide variety of concretes. Such cement composites have good mechanical properties but may be brittle, weak in tension and low in toughness.

Use of organic fibers, including wood fiber or other cellulosic materials, to reinforce cementitious materials has been well known for centuries. Wood-cement composites, known as excelsior board, including those using Portland cement as a binder, have been used for decades in various construction applications. Wood fiber reinforced cement complements the high tensile strength, toughness, impact resistance of wood with the fire resistance, durability and dimensional stability of cement-based materials.

International Patent Application Publication No. WO 2000/71336 describes a wood fiber-cement composite formed by pretreating the wood fibers with an aqueous chemical such as an acrylic emulsion or an alkylalkoxysilane before combining with cement.

U.S. Pat. No. 7,148,270 describes methods for providing a polymer-modified fiber-cement composite by forming an aqueous composition including admixing an emulsion polymer having a glass transition temperature (Tg) of from −25° C. to 150° C., cement, cellulosic fibers, siliceous material, and water; forming a composite precursor by removal of at least some of the water; and curing/drying the composite precursor at a temperature at least 10° C. higher than the Tg of the polymer. In an alternative embodiment the emulsion polymer is applied to the composite precursor.

Use of polymer fibers to improve dimensional stability has been extensively tried with minimal success in improving fiber cement performance, with polyvinyl acetate (PVA) fiber being the most viable alternative. However, PVA fibers cannot be processed in an autoclave due to degradation, which negatively affects the fiber cement performance. Therefore, PVA fiber use in fiber cement is limited to processes where fiber cement is cured at ambient conditions, which significantly increases the production time.

Acrylic emulsion polymers such as DOW's PRIMAL™ products have been used to coat fiber cement composites. There is a market need to better protect the cellulose fibers in fiber cement.

U.S. Pat. No. 8,841,379 discloses a method to form an aqueous dispersion comprising a blend composition comprising or consisting essentially of about 75 to about 99.9 weight % of an ionomer composition and about 0.1 to about 25 weight % of an ethylene acrylate ester copolymer composition, a grafted polyolefin composition or a combination thereof, the method comprising mixing the solid blend composition with water heated to a temperature from about 80 to about 100° C.

### SUMMARY OF THE INVENTION

Provided herein is a polymer-modified fiber-cement composite comprising cement, cellulosic fibers, siliceous material, and a blend of
(a) about 60 to about 99.9 weight % of an ionomer composition comprising or consisting essentially of a parent acid copolymer that comprises copolymerized units of ethylene and about 18 to about 30 weight % of copolymerized units of acrylic acid or methacrylic acid, based on the total weight of the parent acid copolymer, the acid copolymer having a melt flow rate (MFR) from about 200 to about 1000 g/10 min., measured according to ASTM D1238 at 190° C. with a 2160 g load, wherein about 50% to about 70% of the carboxylic acid groups of the copolymer, based on the total carboxylic acid content of the parent acid copolymer as calculated for the non-neutralized parent acid copolymer, are neutralized to carboxylic acid salts comprising potassium cations, sodium cations or combinations thereof; and
(b) about 0.1 to about 40 weight %, based on the combination of (a) and (b), of (i) an ethylene elastomer comprising copolymerized units of ethylene, about 45 to about 80 weight % of copolymerized units of at least one alpha,beta-ethylenically unsaturated carboxylic acid ester, based on the total weight of the ethylene elastomer, and optionally about 0.5 to about 10 weight % of copolymerized units of 2-butene-2,4-dioic acid or its derivative, wherein the derivative is an anhydride of the acid or a monoalkyl ester of the acid; (ii) an ethylene dicarboxyl copolymer comprising copolymerized units of ethylene and copolymerized units of a dicarboxyl comonomer comprising an anhydride group, a vicinal pair of carboxylic groups or a carboxylic group adjacent to an alkoxycarbonyl group; (iii) at least one ethylene ester copolymer comprising copolymerized units of ethylene and about 10 to about 45 weight % of copolymerized units of an alpha, beta-ethylenically unsaturated carboxylic acid ester, based on the total weight of the ethylene ester copolymer; (iv) a grafted polyolefin composition comprising a parent polyolefin grafted with about 0.1 to about 5 weight % of an alpha,beta-ethylenically unsaturated carboxylic acid or anhydride, based on the total weight of the grafted polyolefin; or (v) a combination of any of (i), (ii), (iii) or (iv).

Further provided herein is a method for providing the polymer-modified fiber-cement composite comprising: forming the aqueous composition comprising admixing the aqueous dispersion, cement, cellulosic fibers, siliceous material, and water; forming the composite precursor by removal of at least some of the water; and curing/drying the composite precursor.

### DETAILED DESCRIPTION OF THE INVENTION

Unless otherwise defined, all technical and scientific terms used herein have the same meaning as commonly understood by one of ordinary skill in the art to which this invention belongs. In case of conflict, the specification, including definitions, will control.

Although methods and materials similar or equivalent to those described herein can be used in the practice or testing of the invention, suitable methods and materials are described herein.

Unless stated otherwise, all percentages, parts, ratios, etc., are by weight.

When an amount, concentration, or other value or parameter is given as either a range, preferred range or a list of lower preferable values and upper preferable values, this is to be understood as specifically disclosing all ranges formed from any pair of any lower range limit or preferred value and any upper range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

When the term “about” is used in describing a value or an end-point of a range, the disclosure should be understood to include the specific value or end-point referred to.

As used herein, the terms “comprises,” “comprising,” “includes,” “including,” “containing,” “characterized by,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or.

The transitional phrase “consisting essentially of” limits the scope of a claim to the specified materials or steps and those that do not materially affect the basic and novel characteristic(s) of the claimed invention. Where applicants have defined an invention or a portion thereof with an open-ended term such as “comprising,” unless otherwise stated the description should be interpreted to also describe such an invention using the term “consisting essentially of”.

Use of “a” or “an” are employed to describe elements and components of the invention. This is merely for convenience and to give a general sense of the invention. This description should be read to include one or at least one and the singular also includes the plural unless it is obvious that it is meant otherwise.

In describing certain polymers it should be understood that sometimes applicants are referring to the polymers by the monomers used to produce them or the amounts of the monomers used to produce the polymers. While such a description may not include the specific nomenclature used to describe the final polymer or may not contain product-by-process terminology, any such reference to monomers and amounts should be interpreted to mean that the polymer comprises copolymerized units of those monomers or that amount of the monomers, and the corresponding polymers and compositions thereof.

The term “copolymer” is used to refer to polymers formed by copolymerization of two or more monomers. Such copolymers include dipolymers consisting essentially of two copolymerized comonomers.

As used herein, “disperse,” “dispersing” and related terms refer to a process in which solid articles such as pellets of polymer are mixed with water and over a brief period of time disappear into the liquid phase. The terms “aqueous dispersion” and “dispersion” describe a transparent, free-flowing liquid with no solids visible to the human eye. No characterization is made regarding the interaction of the polymer molecules with the water molecules in such aqueous dispersions. “Self-dispersible” means that the material disperses readily in hot (80 to 100° C.) water without need for additional dispersants or reagents.

Provided herein are ethylene copolymer dispersions that may be used to modify wood pulp slurry, inorganic filler slurry or fiber cement mixture, or to coat fiber cement microlayers or composites to improve water resistance and freeze/thaw stability. Of particular interest is the use of ethylene copolymer blends containing a water dispersible ionomer as the continuous matrix and at least one other ethylene copolymer.

Further provided herein is a process for forming a polymer-modified fiber-cement composite that exhibits improved performance in at least one of: resistance to water, freeze-thaw stability, chemical resistance, impact strength, abrasion resistance, flexural strength, tensile strength, % strain at failure, dimensional stability, interlaminar bond strength, and fiber to matrix bond strength relative to a corresponding composite absent the polymer. Further, polymer modification may permit a composite with a reduced level of fibers that is equal in performance to an unmodified composite. Advantageously, fiber is typically more expensive than cement. Polymer modification may also allow equal performance from a thinner and lighter fiber-cement board, which facilitates transportation, handling and installation.

By using the invention, fiber cement manufacturers may be able to better control dimensional stability, thereby improving the durability of their product. This invention may have broader applications in other materials that require improved protection of cellulose fibers, improved dimensional stability, or adhesion to cement particles.

The polymer blend composition described herein comprises (a) about 60 to about 99.9 weight %, based on the combination of (a) and (b), of an ionomer composition, and (b) about 0.1 to about 40 weight, based on the combination of (a) and (b), of (i) an ethylene elastomer; (ii) ethylene dicarboxyl copolymer; (iii) at least one ethylene ester copolymer; (iv) a grafted polyolefin; or (v) a combination of any of (i), (ii), (iii) or (iv).

### Ionomer Composition

Suitable ionomers are derived from parent acid copolymers comprising copolymerized units of ethylene and about 18 to about 30 weight % of copolymerized units of an alpha, beta-ethylenically unsaturated carboxylic acid such as acrylic acid or methacrylic acid. Preferably, the parent acid copolymer comprises about 19 to about 25 weight %, or more preferably about 19 to about 23 weight %, of the alpha, beta-ethylenically unsaturated carboxylic acid, based on the total weight of the parent acid copolymer.

Preferably, the alpha, beta-ethylenically unsaturated carboxylic acid is methacrylic acid. Of note are acid copolymers consisting essentially of copolymerized units of ethylene and copolymerized units of the alpha, beta-ethylenically unsaturated carboxylic acid and 0 weight % of additional comonomers; that is, dipolymers of ethylene and the alpha, beta-ethylenically unsaturated carboxylic acid. Preferred acid copolymers are ethylene methacrylic acid dipolymers.

The parent acid copolymers may be polymerized as described in U.S. Pat. Nos. 3,404,134; 5,028,674; 6,500,888; and 6,518,365, for example.

The parent acid copolymers preferably have a melt flow rate (MFR) of about 200 to about 1000 grams/10 min as measured by ASTM D1238 at 190° C. using a 2160 g load. A similar ISO test is ISO 1133. Alternatively, the parent acid copolymers have an MFR that ranges from a lower limit of 200, 250 or 300 to an upper limit of 400, 500, 600 or 1000 g/10 min. The preferred melt flow rate of the parent acid copolymer provides ionomers with favorable physical properties in the final shaped article while still allowing for rapid self-dispersion in hot water. Ionomers derived from parent acid copolymers with melt flow rates below about 200 grams/10 min have minimal hot water self-dispersibility, while ionomers derived from parent acid copolymer melt flow rates of greater than about 1000 grams/10 minutes may reduce the physical properties in the intended end use.

In some embodiments, blends of two or more ethylene acid copolymers may be used, provided that the aggregate components and properties of the blend fall within the limits described above for the ethylene acid copolymers. For example, two ethylene methacrylic acid dipolymers may be used such that the total weight % of methacrylic acid is about 18 to about 30 weight % of the total polymeric material and the melt flow rate of the blend is about 200 to about 1000 grams/10 min.

Suitable ionomers are produced from the parent acid copolymers, wherein from about 50 to about 70%, or preferably from about 55 to about 60%, such as about 60%, of the total carboxylic acid groups of the parent acid copolymers, as calculated for the non-neutralized parent acid copolymers, are neutralized to form carboxylic acid salts with cations as counterions. Any cation that is stable under processing conditions is suitable. Preferred are monovalent and divalent cations, including without limitation alkali metal cations, such as sodium, potassium or lithium; alkaline earth metal cations, such as zinc cations; and combinations of two or more monovalent and divalent cations. Monovalent cations are more preferred, and sodium and potassium cations are still more preferred. Ionomers having cations that consist essentially of sodium cations are notable. The parent acid copolymers may be neutralized using methods described in, for example, U.S. Pat. No. 3,404,134.

Importantly, the ionomer compositions combine the properties of being self-dispersible in hot water along with being thermoplastic, allowing for melt fabrication into many articles of commerce. Preferably, the ionomers used herein have a melt flow rate (MFR) of at least 1 gram/10 min, such as about 1 to about 20 grams/10 min, as measured by ASTM D1238 at 190° C. using a 2160 g load. More preferably, the ionomer composition has a MFR of about 1 to about 10 grams/10 min, and most preferably has a MFR of about 1 to about 5 grams/10 min. The combination of the above described parent acid copolymer melt flow rates and the neutralization levels provides ionomers which combine the properties of being easily self-dispersible in hot water and easily melt fabricated into articles of commerce.

In some embodiments, blends of two or more ionomers may be used, provided that the aggregate components and properties of the blend fall within the limits described above for the individual ionomers.

The ionomer composition may also contain other additives known in the art. The additives may include, but are not limited to, processing aids, flow enhancing additives, lubricants, pigments, dyes, flame retardants, impact modifiers, nucleating agents, anti-blocking agents such as silica, thermal stabilizers, UV absorbers, UV stabilizers, surfactants, chelating agents, and coupling agents.

The polymer blend composition further comprises one or more other ethylene copolymers selected from the group consisting of ethylene elastomer; an ethylene dicarboxyl copolymer; an ethylene ester copolymer; and a grafted polyolefin.

### Ethylene Elastomer

Suitable ethylene elastomers may comprise, be produced from, or consist essentially of copolymerized units of ethylene; about 45 to about 80 weight %, or about 45 to about 75 weight %, or about 55 to about 80 weight %, or about 50 to about 70 weight %, or about 50 to about 80 weight % of copolymerized units of at least one alpha, beta-ethylenically unsaturated carboxylic acid ester; and optionally about 0.5 to about 10 weight %, about 1 to about 5 weight %, about 1.5 to about 5 weight %, about 1.5 to about 4 weight %, or about 1.5 to about 3 weight %, of copolymerized units of 2-butene-2,4-dioic acid or its derivative, wherein the derivative is an anhydride of the acid or a monoalkyl ester of the acid, and wherein the weight percentages are based on the total weight of the ethylene elastomer.

A suitable dipolymer may comprise or be produced from ethylene and about 45 to about 80 weight %, 45 to about 75 weight %, or 50 to 70 weight % of a (meth)acrylate or alkyl (meth)acrylate, such as methyl acrylate. The alkyl group may comprise 1 to 8 carbons, preferably 1 to 4 carbons. The dipolymer can have a number average molecular weight (MO above 20,000, above 30,000, above 40,000, or above 55,000 with an upper limit of about 100,000 or about 150,000 daltons; and melt index from 2 to 20, or from 2 to 12 g/10 min, as measured by ASTM D1238 at 190° C. using a 2160 g load; and preferably a polydispersity from about 2 to about 10.

A suitable terpolymer may comprise or be produced from ethylene, an alkyl (meth)acrylate, and a 2-butene-2,4-dioic acid or its derivative. The repeat units derived from alkyl (meth)acrylate can be about 45 to about 70 weight %. The repeat units derived from 2-butene-2,4-dioic acid or its derivative can be about 0.5 to about 10 weight %, about 1 to about 5 weight %, about 1.5 to about 5 weight %, about 1.5 to about 4 weight %, or about 1.5 to about 3 weight %, in which the derivative is an anhydride of the acid or a monoalkyl ester of the acid. The alkyl group in the monoalkyl ester can have 1 to about 6 carbon atoms. The repeat units derived from ethylene can comprise the remainder. The copolymer can have a number average molecular weight (MO above 20,000, above 40,000, or above 43,000, with an upper limit of about 100,000 or about 150,000 daltons; a melt index preferably from about 1 to about 30 g/10 min; and preferably a polydispersity from about 2 to about 10.

A terpolymer or a tetrapolymer can comprise or be produced from ethylene, a first alkyl (meth)acrylate, a second alkyl (meth)acrylate, and, optionally, a 2-butene-2,4-dioic acid or its derivative. The amount of repeat units derived from the first alkyl (meth)acrylate may range about 10 to about 40 weight % or about 20 to about 30 weight %, and the amount of repeat units derived from the second alkyl (meth)acrylate may range about 15 to about 65 weight % or about 35 to about 45 weight %, such that the total of the copolymerized alkyl (meth)acrylate repeat units is about 45 to about 80 weight %, based on the total weight of the ethylene elastomer. The first alkyl (meth)acrylate and the second alkyl (meth)acrylate are different although they can be selected from the same group. The first alkyl (meth)acrylate and the second alkyl (meth)acrylate can each independently have 1 to 4 carbons in the alkyl group. The repeat units derived from the 2-butene-2,4-dioic acid or its derivative can be 0 to about 5 weight %, about 1 to 5 weight %, or about 2 to 5 weight %, based on the total weight of the ethylene elastomer. As described above, the derivative can be an anhydride of the acid or a monoalkyl ester of the acid wherein the alkyl group in the monoalkyl ester has from 1 to about 6 carbon atoms. The repeat units derived from ethylene can comprise the remainder, that is, the amount of copolymerized ethylene is complementary to the amounts of copolymerized alkyl (meth)acrylate(s) and 2-butene-2,4-dioic acid or its derivative(s). The terpolymer or a tetrapolymer can have a number average molecular weight (Mₙ) above 40,000, alternatively above 48,000, alternatively above 60,000; preferably a Mₙ with an upper limit of about 100,000 or about 150,000 daltons; a melt index (MI) preferably about 3 to about 30 g/10 minutes and a polydispersity preferably from about 2 to about 12, or from 2.5 to 10.

In some embodiments, the ethylene copolymer is cross-linkable to form a thermoset material. In these embodiments, the ethylene elastomer or ethylene acrylic elastomer is provided in a cross-linkable composition that further comprises or is produced from a curing agent; one or more additional polymers including thermosets such as epoxy resins, phenolic resins or vinyl ester resins subject to further curing; or thermoplastics such as polyamides. The cross-linkable composition is prevented from cross-linking until after the dispersion is formed, or until after the end-use of the dispersion is achieved, for example by maintaining processing temperatures below the activation temperature of any curing agent, or by preventing exposure to any initiator until cross-linking is desired.

Optionally, the ethylene copolymer further comprises one or more additives including filler, reinforcing fiber, fibrous structure of pulps, or combinations of two or more thereof to produce a compounded composition.

Specific examples of suitable ethylene elastomers include, without limitation, ethylene methyl acrylate dipolymer, ethylene butyl acrylate dipolymer, ethylene methacrylate dipolymer, ethylene methyl methacrylate dipolymer, ethylene glycidyl methacrylate dipolymer, ethylene methyl acrylate butyl acrylate terpolymer, ethylene methyl acrylate glycidyl methacrylate terpolymer, ethylene butyl acrylate glycidyl methacrylate terpolymer, ethylene methyl acrylate butyl acrylate methyl hydrogen maleate tetrapolymer, ethylene methyl acrylate butyl acrylate ethyl hydrogen maleate tetrapolymer, ethylene methyl acrylate butyl acrylate propyl hydrogen maleate tetrapolymer, ethylene methyl acrylate butyl acrylate butyl hydrogen maleate tetrapolymer, or combinations of two or more thereof.

Ethylene elastomers can be readily produced by copolymerizing, for example, ethylene and one or two alkyl (meth)acrylate(s) having from 1 to 4 carbons in the alkyl group, in the presence of a free-radical polymerization initiator including for example peroxygen compounds or azo compounds. Copolymers with acid cure sites (2-butene-2,4-dioic acid or its derivative) can be similarly produced by copolymerizing ethylene, alkyl (meth)acrylate(s) and 2-butene-2,4-dioic acid moieties, anhydrides, or monoalkyl esters thereof. The copolymerizations can be run by continuously feeding ethylene and the comonomer(s), a free radical initiator, and optionally a solvent such as methanol or the like (see e.g., U.S. Pat. No. 5,028,674) to a stirred autoclave of the type disclosed in U.S. Pat. No. 2,897,183. Alternatively, other high-pressure reactor designs with sufficient mixing, residence time, temperature and pressure control, generally known in the art as an autoclave, operated either alone or in series with or without inter-stage cooling or heating, with multiple compartments and feed zones may be employed. Reactor dimensions such as volume, length and diameter may also influence operating conditions. The rate of conversion may depend on variables such as the polymerization temperature and pressure, monomer feed temperature, the different monomers employed, concentration of the monomers in the reaction mixture, and residence time for the desired yield and copolymer composition. It may be desirable to adjust the residence time and, in some cases, to use a telogen (chain transfer/chain terminating agent) such as propane, to help adjust the molecular weight. The reaction mixture is continuously removed from the autoclave. After the reaction mixture leaves the reaction vessel, the copolymer can be separated from the unreacted monomers and solvent (if solvent is used) by, for example, vaporizing the unpolymerized materials and solvent under reduced pressure and at an elevated temperature. The copolymerization can be carried out in a pressurized reactor at elevated temperature, from 120° C. to 200° C., or from 135° C. to 170° C.; pressures of from 1800 to 3000 kg/cm², or from 2000 to 2800 kg/cm²; and feed temperatures from 30° C. to 90° C., or from 50° C. to 90° C. Appropriate peroxide initiators for the copolymerization process may depend on the reactor operating conditions, such as temperature and pressure, comonomers used, comonomer concentration, and inhibitors that are typically present in commercially available comonomers. The initiator can be employed neat as a liquid, dissolved or diluted in a suitable solvent such as odorless mineral spirits or mixed with another different initiator. Common classes of organic peroxides useful as free radical initiators include dialkyl peroxides, peroxy esters, peroxy dicarbonates, peroxy ketals, and diacyl peroxides. Examples of suitable peroxides include di(3,3,5-trimethyl hexanoyl) peroxide, tert-butyl peroxypivalate, tert-butyl peroxyneodecanoate, di(sec-butyl) peroxydicarbonate, and tert-amyl peroxyneodecanoate. These and other suitable peroxides are available under the LUPEROX® from Arkema or the TRIGONOX® from Akzo Nobel. Similarly, suitable azo initiators can be used. After the continuous operation has reached a steady state, the total per-pass conversion of monomers to polymer may vary from 5 to 25 weight %. The peroxides used are preferably those that decompose rapidly within the range of 150 to 250° C. Examples of suitable peroxides include dicumyl peroxide, 1,1-di-(t-butylperoxy)-3,3,5-trimethylcyclohexane, 2,5-bis(t-butylperoxy)-2,5-dimethyl hexane, and α,α-bis(t-butylperoxy)-diisopropylbenzene. The peroxide may be dissolved in mineral spirits. The amount of peroxide injected may vary with the acrylate types, the level of the residuals, and the twin-screw extruder processing conditions. A typical range may be from 200 ppm to 8000 ppm, alternatively from 500 ppm to 5000 ppm. Residual levels in the finished copolymer are preferably below 2500 ppm, more preferably below 1500 ppm, and even more preferably below 1000 ppm.

Suitable ethylene elastomers can be produced by well-known processes such as those described in U.S. Pat. Nos. 7,521,503; 7,544,757; and 7,608,675. In addition, suitable ethylene elastomers are commercially available as VAMAC® from DuPont.

It may be desirable to increase the molecular weight of an ethylene elastomer. A blend of the uncrosslinked copolymer and a curing agent, other additives and/or polymers is subjected to a curing step at sufficient time, temperature to achieve covalent chemical bonding (i.e., crosslinking). Crosslinking involves curing the compounded composition at elevated temperature for sufficient time to crosslink the copolymer. For example, a crosslinked ethylene copolymer may start to be formed and cured using known procedures at about 90° C. to about 140° C. as much as 60 minutes. Additional cure/annealing heating may be conducted at about 90° C. to about 140° C. for several hours. Curing may occur during the drying process discussed below in preparing the polymer-modified fiber cement composite.

### Ethylene Dicarboxyl Copolymer

Alternatively, the polymer blend composition may comprise or be produced from an ethylene dicarboxyl copolymer comprising, produced from, or consisting essentially of copolymerized units of ethylene and copolymerized units of a dicarboxyl comonomer comprising an anhydride group, a vicinal pair of carboxylic groups or a carboxylic group adjacent to an alkoxycarbonyl group. This copolymer is obtained by copolymerization of at least ethylene and at least one comonomer capable of copolymerizing with ethylene such as an anhydride or a functional equivalent thereof, such as a vicinal pair of carboxylic groups or a carboxylic group adjacent to an alkoxycarbonyl group, wherein the alkoxy group contains up to 20 carbon atoms. The comonomer includes C₄-C₈ unsaturated anhydrides, C₄-C₈ unsaturated acids having at least two carboxylic groups, monoesters or diesters of C₄-C₈ unsaturated acids having at least two carboxylic groups, and mixtures thereof.

Examples of suitable comonomers include unsaturated anhydrides such as maleic anhydride and itaconic anhydride; 1,4-butenedioic acids (e.g. maleic acid, fumaric acid, itaconic acid and citraconic acid); and C₁-C₂₀ alkyl monoesters of the 1,4-butenedioc acids, including methyl hydrogen maleate, ethyl hydrogen maleate, propyl hydrogen fumarate, and 2-ethylhexyl hydrogen fumarate. Of these, maleic anhydride, ethyl hydrogen maleate and methyl hydrogen maleate are preferred. Maleic anhydride, ethyl hydrogen maleate (EHM), or a mixture thereof, is most preferred.

Preferred are copolymers of ethylene and monoalkyl maleates (also known as alkyl hydrogen maleates). As used herein, the term “ethylene/monoalkyl maleate copolymers” refers to such copolymers prepared from ethylene and a maleic acid monoester (sometimes referred to as a “half-ester,” wherein one carboxyl group of the maleic moiety is esterified and the other is an unesterified carboxylic acid).

Terpolymers or tetrapolymers comprise other comonomers in addition to the ethylene and the dicarboxyl comonomer. The copolymers include E/X/Y terpolymers, wherein E is ethylene; X is a monomer selected from the group consisting of vinyl acetate and alkyl (meth)acrylates; and Y is a maleic acid monoester, including maleic monoesters of C₁ to C₄ alcohols, such as for example, methyl, ethyl, n-propyl, isopropyl, and n-butyl alcohols, wherein X is less than 15 weight %, and preferably less than 5 weight % of the terpolymer. Examples of monomers suitable for inclusion as component X are (meth)acrylic acid esters of C₁ to C₄ alcohols. For example, suitable acrylate esters include methyl acrylate and butyl acrylate and suitable alkyl methacrylate esters include methyl methacrylate and n-butyl methacrylate. Preferably, when the copolymer is a higher order polymer such as a terpolymer, the amount of combined comonomers other than ethylene is about 6 to about 30 weight % of the higher order polymer. For such copolymers, the alcohol moiety used in the maleic acid monoester comonomer may be the same as that used in the alkyl (meth)acrylate comonomer, or it may be different.

Specific examples of the ethylene dicarboxyl copolymer include ethylene/maleic acid monoester dipolymers such as ethylene/ethyl hydrogen maleate dipolymer, ethylene/maleic acid monoester/methyl acrylate terpolymers, ethylene/maleic acid monoester/methyl methacrylate terpolymers, ethylene/maleic acid monoester/ethyl acrylate terpolymers, ethylene/maleic acid monoester/ethyl methacrylate terpolymers, ethylene/maleic acid monoester/n-butyl acrylate terpolymers and ethylene/maleic acid monoester/n-butyl methacrylate terpolymers.

Of particular note are ethylene/alkyl hydrogen maleate copolymers wherein the alkyl group is ethyl.

The copolymer may comprise about 6 to about 25 weight % copolymerized units of the dicarboxyl comonomer, based on the weight of the copolymer. Alternatively, the level of copolymerized units of the dicarboxyl comonomer (for example ethyl hydrogen maleate) is from a lower limit of about 6, 8 or about 10 weight % to an upper limit of about 10, about 15, about 18, about 20, or about 25 weight %, based on the total weight of the ethylene dicarboxyl copolymer. The amount of copolymerized ethylene is complementary to the amount of dicarboxyl comonomer and other comonomer(s), if present.

The copolymer may have a melt index from about 5 to about 400 g/10 min, preferably about 5 or about 10 to about 100 g/min. A representative copolymer is a random copolymer having a melt index of about 5 to 100 grams/10 minutes and consisting essentially of copolymerized ethylene and a monoalkyl ester of a 1,4-butenedioic acid in which the alkyl group of the ester has 1 to 4 carbon atoms. Preferably, the copolymer is a dipolymer of ethylene and about 4 to about 25 weight %, or more preferably about 8 to about 20 weight % of ethyl hydrogen maleate (an “EMAME” copolymer). A specific polymer may comprise from about 8 to about 10 weight % of ethyl hydrogen maleate. Another specific copolymer comprises about 15 weight % of ethyl hydrogen maleate. Such copolymers are commercially available from DuPont under the trademark Fusabond®.

Ethylene/ethyl hydrogen maleate/alkyl ester terpolymers are also known. For example, a terpolymer of 46.4% ethylene, 50% methyl acylate and 3.6% of monoethyl maleate is described in U.S. Pat. No. 3,972,961. Preferably, the amount of MAME in the copolymer is from about 6 to about 20 weight % and the amount of additional comonomer (vinyl acetate, alkyl acrylate or alkyl methacrylate is less than or equal to 15 or less than or equal to 6 weight % of the terpolymer. Preferably the EMAME copolymer or the EMAME terpolymer has a melting point higher than 80° C.

These copolymers may be synthesized by random copolymerization of ethylene and the particular comonomer(s) in a high-pressure free radical process, generally an autoclave process. For example, ethylene/monoalkyl maleate copolymers can be obtained using a suitable high-pressure process described, for example, in U.S. Pat. No. 4,351,931. Some examples of this type of ethylene/ester copolymer are also described in U.S. Patent Application Publication No. 2005/0187315.

### Ethylene Ester Copolymer

Alternatively, the polymer blend composition may comprise an ethylene ester copolymer. Suitable ethylene ester copolymers comprise or consist essentially of copolymerized units of ethylene and about 10 to about 45 weight % of copolymerized units of an alpha, beta-ethylenically unsaturated carboxylic acid ester, based on the total weight of the ethylene ester copolymer. Preferably, the ethylene ester copolymer comprises about 15 to about 40 weight %, or more preferably about 20 to about 35 weight %, of the alpha, beta-ethylenically unsaturated carboxylic acid ester, based on the total weight of the copolymer. Of note is the dipolymer consisting essentially of copolymerized units of ethylene and copolymerized units of an alpha, beta-ethylenically unsaturated carboxylic acid ester.

The alpha, beta-ethylenically unsaturated carboxylic acid ester comonomer includes, but is not limited to, methyl acrylate, methyl methacrylate, ethyl acrylate, ethyl methacrylate, propyl acrylate, propyl methacrylate, isopropyl acrylate, isopropyl methacrylate, butyl acrylate, butyl methacrylate, isobutyl acrylate, isobutyl methacrylate, tert-butyl acrylate, tert-butyl methacrylate, octyl acrylate, octyl methacrylate, undecyl acrylate, undecyl methacrylate, octadecyl acrylate, octadecyl methacrylate, dodecyl acrylate, dodecyl methacrylate, 2-ethylhexyl acrylate, 2-ethylhexyl methacrylate, isobornyl acrylate, isobornyl methacrylate, lauryl acrylate, lauryl methacrylate, 2-hydroxyethyl acrylate, 2-hydroxyethyl methacrylate, glycidyl acrylate, glycidyl methacrylate, poly(ethylene glycol)acrylate, poly(ethylene glycol)methacrylate, poly(ethylene glycol) methyl ether acrylate, poly(ethylene glycol) methyl ether methacrylate, poly(ethylene glycol) behenyl ether acrylate, poly(ethylene glycol) behenyl ether methacrylate, poly(ethylene glycol) 4-nonylphenyl ether acrylate, poly(ethylene glycol) 4-nonylphenyl ether methacrylate, poly(ethylene glycol) phenyl ether acrylate, poly(ethylene glycol) phenyl ether methacrylate, dimethyl maleate, diethyl maleate, dibutyl maleate, dimethyl fumarate, diethyl fumarate, dibutyl fumarate, dimenthyl fumarate, and the like and combinations thereof. Preferable alpha, beta-ethylenically unsaturated carboxylic acid ester comonomers include, but are not limited to, methyl acrylate, ethyl acrylate, isopropyl acrylate, butyl acrylate and combinations thereof. More preferably, the alpha, beta-ethylenically unsaturated carboxylic acid ester comonomer is methyl acrylate.

Mixtures of these ethylene ester copolymers may be used in place of a single ethylene ester copolymer.

Some suitable ethylene ester copolymers are commercially available from DuPont under the trademark Elvaloy® AC.

### Grafted Polyolefin Composition

Alternatively, the polymer blend composition may comprise or be produced from a grafted polyolefin composition. Suitable grafted polyolefin compositions comprise a parent polyolefin grafted with about 0.1 to about 5 weight % of an alpha, beta-ethylenically unsaturated carboxylic acid or anhydride, based on the total weight of the grafted polyolefin.

The parent polyolefin may comprise ethylene-based polymers, such as polyethylene and ethylene-alpha olefin copolymers, propylene-based polymers, such as polypropylene and propylene-alpha olefin copolymers, and propylene-ethylene copolymers. For example, the parent polyolefin may be polypropylene, polyethylene, and copolymers thereof, and blends thereof, as well as ethylene-propylene-diene terpolymers. The parent polyolefin includes homogeneous polymers described in U.S. Pat. No. 3,645,992; high density polyethylene (HDPE) as described in U.S. Pat. No. 4,076,698; heterogeneously branched linear low density polyethylene (LLDPE); heterogeneously branched ultra low linear density polyethylene (ULDPE); homogeneously branched, linear ethylene/alpha-olefin copolymers; homogeneously branched, substantially linear ethylene/alpha-olefin polymers, which can be prepared, for example, by a process disclosed in U.S. Pat. Nos. 5,272,236 and 5,278,272; and high pressure, free radical polymerized ethylene polymers and copolymers such as low density polyethylene (LDPE). Parent polyolefin compositions described in U.S. Pat. No. 6,566,446; 6,538,070; 6,448,341; 6,316,549; 6,111,023; 5,869,575; 5,844,045; or 5,677,383 are also suitable in some embodiments. Blends of polymers can be used as well. In some embodiments, the blends include two different Ziegler-Natta polymers. In other embodiments, the blends can include blends of a Ziegler-Natta and a metallocene polymer. In still other embodiments, the polymer used herein is a blend of two different metallocene polymers. In other embodiments, single site catalysts may be used.

Examples of ethylene-alpha olefin copolymers comprise an alpha-olefin interpolymer of ethylene with at least one comonomer selected from the group consisting of a C₄-C₂₀ linear, branched or cyclic diene; and a compound represented by the formula H₂C═CHR, wherein R is a C₁-C₂₀ linear, branched or cyclic alkyl group or a C₆-C₂₀ aryl group. Examples of suitable comonomers include, without limitation, propylene, 1-butene, 3-methyl-1-butene, 4-methyl-1-pentene, 3-methyl-1-pentene, 1-heptene, 1-hexene, 1-octene, 1-decene, and 1-dodecene. In some embodiments, the interpolymer of ethylene has a density of less than about 0.92 g/cc.

Examples of propylene-alpha olefin copolymers include an alpha-olefin interpolymer of propylene with at least one comonomer selected from the group consisting of ethylene; a C₄-C₂₀ linear, branched or cyclic diene; and a compound represented by the formula H₂C═CHR, wherein R is a R is a C₁-C₂₀ linear, branched or cyclic alkyl group or a C₆-C₂₀ aryl group. Examples of comonomers include ethylene, 1-butene, 3-methyl-1-butene, 4-methyl-1-pentene, 3-methyl-1-pentene, 1-heptene, 1-hexene, 1-octene, 1-decene, and 1-dodecene.

Further examples of parent polyolefins that are suitable for grafting include homopolymers and copolymers (including elastomers) of an olefin such as ethylene, propylene, 1-butene, 3-methyl-1-butene, 4-methyl-1-pentene, 3-methyl-1-pentene, 1-heptene, 1-hexene, 1-octene, 1-decene, and 1-dodecene, as typically represented by polyethylene, polypropylene, poly-1-butene, poly-3-methyl-1-butene, poly-3-methyl-1-pentene, poly-4-methyl-1-pentene, ethylene-propylene copolymer, ethylene-1-butene copolymer, and propylene-1-butene copolymer; copolymers (including elastomers) of an alpha-olefin with a conjugated or non-conjugated diene, as typically represented by ethylene-butadiene copolymer and ethylene-ethylidene norbornene copolymer; and polyolefins (including elastomers) such as copolymers of two or more alpha-olefins with a conjugated or non-conjugated diene, as typically represented by ethylene-propylene-butadiene copolymer, ethylene-propylene-dicyclopentadiene copolymer, ethylene-propylene-1,5-hexadiene copolymer, and ethylene-propylene-ethylidene norbornene copolymer.

Preferably, the grafted polyolefin is made from a parent polyolefin that is a copolymer of ethylene and an alpha-olefin having 3 to 20 carbons having a density of about 0.92 g/cc (ASTM D792) or less, or about 0.90 g/cc or less, about 0.88 g/cc or less, or about 0.88 to about 0.84 g/cc. Also preferably, the parent polyolefin is grafted with about 0.1 to about 5 weight % of an alpha, beta-ethylenically unsaturated carboxylic acid or anhydride. The grafted polyolefin is made by grafting the alpha, beta-ethylenically unsaturated carboxylic acid or anhydride onto the parent polyolefin.

Preferably, the parent polyolefin is a polyolefin copolymer comprising ethylene and another alpha-olefin comonomer. The parent polyolefin copolymer comprises at least two monomers, but may incorporate more than two comonomers, such as terpolymers, tetrapolymers and the like. Preferably, the parent polyolefin copolymer comprises from a lower limit of about 5 weight %, about 15 weight %, about 20 weight % or about 25 weight % to an upper limit of about 35 weight %, about 40 weight %, about 45 weight % or about 50 weight % of other copolymerized alpha-olefin comonomer(s) and a complementary amount of copolymerized ethylene, all based on the total weight of the parent polyolefin copolymer.

The alpha-olefin comonomer preferably contains from 3 to 20 carbons and may be a linear, branched or cyclic alpha-olefin. Preferable alpha-olefins are selected from the group consisting of propene, 1-butene, 3-methyl-1-butene, 4-methyl-1-pentene, 1-hexene, 1-heptene, 1-octene, 1-decene, 1-dodecene, 1-tetradecene, 1-hexadecene, 1-octadecene, 3-cyclohexyl-1-propene, vinyl cyclohexane and the like and mixtures thereof. The alpha-olefin comonomer preferably contains 3 to 10 carbons. The density of the alpha-olefin copolymer will generally depend on the type and level of alpha-olefin incorporated.

The parent polyolefin copolymer may optionally incorporate a minor amount of one or more other olefinic comonomers; for example cyclic olefins such as norbornene; styrene; dienes such as dicyclopentadiene, ethylidene norbornene and vinyl norbornene; and the like and mixtures thereof. When included, the optional comonomer(s) may be incorporated at a level of about 15 weight % or less, based on the total weight of the parent polyolefin copolymer.

The parent polyolefin may be produced by any known method and may be catalyzed with any known polymerization catalyst such as, for example, radical-, Ziegler-Natta-, metallocene-, or other single-site catalyzed polymerizations. See, e.g., U.S. Pat. Nos. 3,645,992; 5,026,798; 5,055,438; 5,057,475; 5,064,802; 5,096,867; 5,132,380; 5,231,106; 5,272,236; 5,278,272; 5,374,696; 5,420,220; 5,453,410; 5,470,993; 5,703,187; 5,986,028; 6,013,819; 6,159,608; and European Patent No. EP514828.

Blends of two or more parent polyolefin copolymers may be used.

The grafted polyolefin comprises an alpha, beta-ethylenically unsaturated carboxylic acid or anhydride grafted to the parent polyolefin. In a grafted polymer, none of the atoms originally contained in the alpha, beta-ethylenically unsaturated carboxylic acid or anhydride moiety are included in the polymer backbone. The alpha, beta-ethylenically unsaturated carboxylic acid or anhydride preferably is selected from the group consisting of maleic anhydride, maleic acid, fumaric acid, acrylic acid, methacrylic acid, itaconic anhydride, itaconic acid, citraconic acid, citraconic anhydride, crotonic acid, crotonic anhydride, methyl crotonic acid, cinnamic acid, endo-bicyclo-[2.2.1]-5-heptene-2,3-dicarboxylic acid, endo-bicyclo-[2.2.1]-5-heptene-2,3-dicarboxylic anhydride, cis-4-cyclohexene-1,2-dicarboxylic acid, cis-4-cyclohexene-1,2-dicarboxylic anhydride and the like and mixtures thereof. Metal salts, anhydrides, esters, amides or imides of the above acids may also be used. More preferably, the alpha, beta-ethylenically unsaturated carboxylic acid or anhydride is maleic anhydride.

The alpha, beta-ethylenically unsaturated carboxylic acid or anhydride may be grafted onto the parent polyolefin by any known method. For example, the alpha, beta-ethylenically unsaturated carboxylic acid or anhydride may be grafted onto the parent polyolefin by the methods described in U.S. Pat. Nos. 3,236,917; 3,932,368; 4,612,155; 4,888,394; 4,950,541; 5,194,509; 5,346,963; 5,523,358; 5,705,565; 5,744,250; 5,955,547; 6,545,091; 7,408,007; U.S. Patent Appln. Publn. Nos. 2008/0078445 and 2008/0115825; and European Patent No. EP0266994.

The level of the alpha, beta-ethylenically unsaturated carboxylic acid or anhydride grafted onto the parent polyolefin is preferably from about 0.1 to about 5 weight %, based on the total weight of the grafted polyolefin. The level of the alpha, beta-ethylenically unsaturated carboxylic acid or anhydride is preferably from about 0.3 to 4 weight % or from about 0.5 to 2 weight %, based on the total weight of the grafted polyolefin.

### Polymer Blend Composition

The polymer blend composition comprises, is produced from, or consists essentially of (a) about 60 to about 99.9 weight %, or about 75 to about 99 weight %, or about 80 to about 99 weight %, or about 90 to about 99 weight %, or about 95 to about 99 weight %, based on the total weight of (a) and (b), of an ionomer composition, and (b) about 0.1 to about 40 weight %, or about 1 to about 25 weight %, or about 1 to about 20 weight %, or about 0.1 to about 10 weight %, or about 1 to about 5 weight %, based on the total weight of (a) and (b), of (i) an ethylene elastomer; (ii) ethylene dicarboxyl copolymer; (iii) at least one ethylene ester copolymer; (iv) a grafted polyolefin; or (v) a combination of two or more of (i), (ii), (iii) or (iv) in any ratio.

Of note is the polymer blend composition consisting essentially of the ionomer and at least one ethylene elastomer, such as a blend comprising about 3 to about 15 weight % of one elastomer or about 3 to about 15 weight % of a combination of two different elastomers and a complementary amount of ionomer. Also of note is the blend composition consisting essentially of the ionomer and the ethylene dicarboxyl copolymer. Also of note is the blend composition consisting essentially of the ionomer and the ethylene ester copolymer, or a combination of ethylene ester copolymers. Also of note is the blend composition consisting essentially of the ionomer and the grafted polyolefin.

The polymer blend composition can be produced by any mixing process known in the art. High shear, intensive melt mixing processes are preferred. Preferably, such a process would involve intensive mixing of the molten ionomer composition with the one or more other ethylene copolymers. For example, the intensive mixing may be provided through static mixers, rubber mills, Brabender mixers, Buss kneaders, single screw extruders or twin screw extruders. Extruders are the most convenient to use because of their high throughput, possible modular construction and ease of assembly, choice of many mixing screws, and ease of control and maintenance of process temperatures.

The ionomer composition and the ethylene elastomer, the ethylene dicarboxyl copolymer, the ethylene ester copolymer or the grafted polyolefin can be dried prior to any mixing step. The resins can be mixed as a dry blend, typically referred to as a “pellet blend” or “salt and pepper blend,” prior to feeding to the melt mixing process. Alternatively, the neat resins can be co-fed through two or more different feeders. In an extrusion process, the resins would typically be fed into the back, feed section of the extruder. Advantageously, however, the resins can be fed independently into two different locations of the extruder. For example, the ionomer composition can be added in the back, feed section of the extruder while the ethylene elastomer or the ethylene dicarboxyl copolymer is fed in the front of the extruder near the die plate. The extruder temperature profile is set up to allow the blend components to melt under the processing conditions. The screw design will also provide stress and, in turn, heat, as the molten resins re mixed. Generally, the melt processing temperature will be within the range of about 50° C. to about 300° C.; however, the exact processing conditions will depend on the resins' physical properties.

After the polymer blend composition has been melt blended, it is removed from the mixer and allowed to cool to a solid. For example, the melt blend may be extruded through a die, cut into pellets and quenched in a cooling bath.

The ethylene elastomer, ethylene dicarboxyl copolymer, ethylene ester copolymer and grafted copolymer are not dispersible in hot water through the dispersion method described below in the absence of the ionomer blend component. Pellets or other articles comprising the ethylene dicarboxyl copolymer, ethylene ester copolymer or grafted copolymer are also not dispersible in hot water, even in the presence of pellets or other articles comprising the dispersible ionomer composition. Without being held to theory, it is believed that the ethylene copolymer(s) must attain a small enough particle size through the melt compounding process to permit the self-dispersibility of the total blend. Hypothetically, the level of the ethylene copolymer(s) is advantageously low, as described above, so that these materials are maintained as the dispersed phase within a continuous phase of ionomer. It is hypothesized that the compatibility of the ethylene copolymer(s) with the ionomer enables them to achieve a small particle size in the blend compositions. For this reason, it is believed that the relatively hydrophobic ethylene copolymer(s) are dispersed in water.

### Dispersion Method

The dispersion method described herein surprisingly allows for the production of aqueous dispersions of the polymer blend composition under very mild conditions, such as low shear (e.g., simply stirring a solid blend of an ionomer and an ethylene copolymer in hot water) and low temperature (less than the boiling point of water at atmospheric pressure). These conditions require less energy than prior art dispersion processes. This dispersion method further provides an inherently safer dispersion process through the use of preformed blend compositions by allowing for the avoidance of strong bases, such as aqueous sodium hydroxide (caustic), aqueous potassium hydroxide or ammonia, during the dispersion process. Notably, the ionomer, the ionomer-ethylene copolymer blend and the aqueous dispersion contain no ammonia.

In one notable embodiment, the method comprises or consists essentially of
(1) providing a solid blend composition comprising or consisting essentially of the polymer blend composition described above;
(2) mixing the solid blend composition with water heated to a temperature from about 80 to about 100° C. under low shear conditions to provide a heated aqueous blend dispersion; and
(3) optionally cooling the heated aqueous blend dispersion to a temperature of about 20 to 30° C., wherein the blend remains dispersed in the liquid phase at the lower temperature.

The dispersion method described herein surprisingly allows for the production of aqueous blend composition dispersions under very mild process conditions, such as low shear (e.g., simply stirring a mixture of hot water and solid blend composition) and low temperature (less than the boiling point of water) at atmospheric pressure, thus requiring less energy than prior art dispersion processes. The dispersion method described herein is inherently safer, owing to the use of preformed polymer blend compositions also to the avoidance of strong bases, such as aqueous sodium hydroxide (caustic), aqueous potassium hydroxide or ammonia. Notably, none of the ionomer, the ionomer-ethylene copolymer blend, or the aqueous dispersion contains ammonia.

In one embodiment, the dispersion method comprises contacting an article comprising the (solid) blend composition with water at a temperature from about 80 to about 100° C. In some embodiments, the temperature is in the range from about 85 to about 90° C. Surprisingly, the blends described herein can be dispersed in water at 80 to 100° C., a temperature that is lower than expected based on the prior art and one that requires significantly less energy to maintain. Nevertheless, blends that are dispersible at temperatures below 100° C. can also be dispersed at higher temperatures.

### Aqueous Dispersion

Further provided herein is an aqueous dispersion comprising or produced from the polymer blend composition. Preferably, the aqueous dispersion is the product of the dispersion process described herein.

The aqueous dispersion preferably comprises from a lower limit of about 0.001 or about 1% to an upper limit of about 10, about 20, about 30 or about 50 weight %, of the blend composition, based on the total weight of the blend composition and the water.

### Article

Further provided herein is an article comprising or produced from the (solid) blend composition described herein. The aqueous dispersions described herein may comprise or be produced from these articles. The article may take any physical form, such as powder, pellets, melt cut pellets, coatings, films, sheets, molded articles and the like. The blend dispersion may be produced in any suitable vessel, such as a tank, vat, pail, or the like. Stirring is useful to provide effective contact of the bulk blend article(s) with water as dispersion proceeds. Preferably the dispersion is produced in about 1 hour or less, such as in about 30 minutes or in about 20 minutes or less. Due to the surprisingly rapid dispersion of the articles comprising the (solid) blend compositions, it is further contemplated that the process may proceed within a pipeline in which the components of the dispersion are charged at one end of the pipeline and form the dispersion as they proceed down the length of the pipeline. For example, the article may be mixed with water and passed through a heated zone, with or without added mixing, such as through static mixers. Alternatively, the article may be mixed with hot water and passed through a pipeline, with or without added mixing, such as through static mixers.

In one embodiment, the article comprising or produced from the blend composition is mixed with water under low shear conditions at room temperature (about 20 to 25° C.) and the temperature is raised to about 80 to about 100° C. In another embodiment, the article comprising the blend composition is mixed with water under low shear conditions at room temperature and the temperature is raised to about 85 to about 90° C.

In another embodiment, the article comprising the blend composition is mixed with water preheated to a temperature of about 80 to about 100° C. under low shear conditions. In another embodiment, the article comprising the blend composition is mixed with water preheated to a temperature of about 85 to about 90° C. under low shear conditions.

### Aqueous Fiber Cement Composition

Further provided herein is an aqueous fiber cement composition. General information regarding aqueous fiber cement compositions is found in U.S. Pat. No. 7,148,270. The aqueous dispersion of water dispersible ionomer and the ethylene elastomer, ethylene dicarboxyl copolymer, ethylene ester copolymer or grafted copolymer can be mixed with additional materials to provide an aqueous fiber cement composition.

The method for providing a polymer-modified fiber-cement composite comprises forming an aqueous composition comprising admixing an aqueous dispersion, cement, cellulosic fibers, siliceous material, and water; forming a composite precursor by removal of at least some of the water; and curing/drying the composite precursor to form the polymer-modified fiber-cement composite.

The term “cement” as used herein includes hydraulic substances which set and harden in the presence of water, such as Portland cement, silicate-based cements, aluminate-based cements, pozzolanic cements and composite cements, for example. The cement is typically present in the amount of 20 to 60 weight %, preferably 30 50 weight %, based on the dry weight of the composite. The total weight of all of the components of the dry composite sums to 100 wt %.

The term “cellulosic fibers” as used herein includes natural fibers, such as wood fibers including ground wood pulp, hardwood pulp, softwood pulp, Kraft pulp, whether bleached or unbleached, including recycled wood-based fibers and non-wood cellulosic fibers and modified fibers such as viscose and rayon, for example. Beneficially, the pulp may be substantially separated into individual fibers before or during the formation of the aqueous composition by techniques known in the paper industry, such as for example by the use of a mechanical beater. The cellulosic fibers are preferably refined to a degree of between 250 to 500 CSF units (Canadian Standard Freeness). The individual fibers typically are 0.1 to 30 mm in length. The cellulosic fibers are typically present in the amount of 5 to 25 weight %, preferably 10 to 20 weight %, based on the dry weight of the composite.

The term “siliceous material” as used herein includes sand, ground sand, silica, and fine quartz. The siliceous material is typically present in the amount of 25 to 65 weight %, preferably 35 to 55 weight %, based on the dry weight of the composite.

The aqueous composition may also include other ingredients such as, for example, natural or synthetic fibers other than cellulosic fibers such as, for example, mineral wool, polyester fibers, polyvinyl alcohol fibers, and polyolefin fibers; fillers, pigments, fly ash, ceramic microspheres, aggregate, antifoaming agents, emulsifiers, crosslinkers, coalescing agents, neutralizers, thickeners or rheology modifiers, humectants, retarders, wetting agents, biocides, plasticizers, colorants, waxes, and anti-oxidants.

The aqueous composition may be prepared by techniques that are well known in the fiber-cement art. For a general reference on methods used for preparing fiber cement compositions, see the 11^{th} Int. Inorganic-Bonded Fiber Composites Conference, 2008, “Technology and Market Considerations for Fiber Cement Composites,” Al Moslemi, pages 113 to 129. The ingredients of the aqueous composition are preferably mixed together as is convenient for efficient dispersion without pretreating or equilibration.

The solids content of the aqueous composition may be from about 2% to about 85% by weight. For use with machinery typically used in forming fiber-cement substrates, such as the Hatschek process and modifications thereof, a solids level of 2 to 10% by weight is preferred. The aqueous composition also includes a complementary amount of water.

This water is the carrier medium of the aqueous polymer dispersion and may optionally include other added water. In the method described herein, at least some of the water is removed from the aqueous composition to provide a composite precursor. Typically, at least some of the water is removed by mechanical means, such as by filtration through a screen, optionally with the assistance of vacuum boxes.

The composite precursor is cured/dried at a temperature which is at least 10° C. higher than the Tg of the polymers. The terms “curing/drying” or “cured/dried” as used herein refer to permitting the composite precursor to lose extra water or other volatile ingredients and to develop properties by physical or chemical processes, such as, for example, cement curing by hydration and, optionally, by ionic or covalent crosslinking. The curing/drying may be accelerated by heating, with or without humidity control, or autoclaving processes such as holding in a steam atmosphere, for example, at a temperature of 120 to 200° C. for a time sufficient to form a solid material, such as from 15 minutes to 12 hours. It is envisioned that the curing/drying may also continue to some extent after such a heating or autoclaving process.

The polymer-modified fiber-cement composite of this invention may be used in various architectural applications such as, for example, roofing, siding, liner board, and backing board.

The following examples are provided to describe the invention in further detail. These examples, which set forth specific embodiments and a preferred mode presently contemplated for carrying out the invention, are intended to illustrate and not to limit the invention.

### Examples

The empirical compositions and properties of the polymers used in these Examples are set forth in Table 1, in which “Tm” refers to the melting temperature, and “MI” refers to melt index.

TABLE 1
Polymers

| | E | MAA | MA | MAME | MI | |
|---|---|---|---|---|---|---|
| | Wt % | Wt % | Wt % | Wt % | 2.16 kg/10 min | Other |
| Ionomer | 91 | 19 | — | — | 2 | Tm 83° C. , |
| (Na⁺, 60% | | | | | | 0.97 g/cm³ |
| neutralized) | | | | | | density |
| ECP-1 | 32 | — | 63 | 4.7 | 8 | — |
| ECP-2 | 38 | — | 62 | — | 14 | — |
| ECP-3 | 91 | — | — | 9 | 25 | Tm 108° C. |

Melt blend A was prepared with 67 wt % ionomer and 33 wt % ECP-3 on a Berstorff ZE-40A×50D UltraTorque® twin-screw extruder (Berstorff GmbH Postfach 61 03 60D-30625 Hannover). The two polymers were fed to the throat of the twin screw extruder via separate Ktron K2G modular gravimetric loss in weight feeders (Coperion K-Tron, 590 Woodbury-Glassboro Road, Sewell, N.J. 08080 USA). The twin screw extruder was fitted with a Gala MAP6 underwater pelletizer (Gala Industries, 181 Pauley St, Eagle Rock, Va. 24085). The extruder screw profile was selected to provide good shear mixing. The extruder operate conditions are summarized in the table below.

TABLE 2
Extruder Operate Conditions

| Blend Number | A | B | F* |
|---|---|---|---|
| Barrel 1 | Uncon- | Uncon- | Uncon- |
| | trolled | trolled | trolled |
| ExtrBarrel2Temp (C.) | 149 | 190 | 190 |
| ExtrBarrel3Temp (C.) | 176 | 186 | |
| ExtrBarrel4Temp (C.) | 179 | 194 | 190 |
| ExtrBarrel5Temp (C.) | 170 | 195 | |
| ExtrBarrel6Temp (C.) | 167 | 188 | |
| ExtrBarrel7Temp (C.) | 173 | 192 | 185 |
| ExtrBarrel8Temp (C.) | 251 | 223 | 192 |
| ExtrBarrel9Temp (C.) | 172 | 191 | |
| ExtrBarrel10Temp (C.) | 176 | 192 | |
| ExtrBarrel11Temp (C.) | 180 | 188 | |
| ExtrBarrel12Temp (C.) | 177 | 186 | |
| ExtrBarrel13Temp (C.) | 179 | | |
| Die Temp (C.) | 200 | 200 | 190 |
| Melt Temp (C.) | 216 | 218 | 227 |
| Extruder Load (%) | 71 | 72 | 70 |
| Extruder screw Speed (RPM) | 350 | 250 | 410 |
| Melt Pressure (PSIG) | 934 | 690 | 414 |
| Gala Cutter Speed (RPM) | 3201 | 2500 | |
| Vacuum Barrel 7 (mm Hg) | None | 760 | |
| Vacuum Barrel 11 (mmHg) | none | 760 | |
| Pellet Blend of A and ionomer (gpm) | | | 200 |
| Ionomer Ktron 1 (kg/hr) | 67 | | |
| ECP-3 Ktron 2 (Kg/hr) | 33 | | |
| Sheer Pelletizer Speed (m/min) | | | 43 |

*Note:
The barrel temperature control zones on the 25 mm W&P were paired up, so that Barrels 2 and 3 are one temperature control zone. Similarly, Barrels 4 and 5, 6 and 7, and 8 and 9 are also paired. The single-hole die was attached to barrel 9 and the strand was water quenched prior to cutting with a Scheer pelletizer model SGS-E (Reduction Engineering GmbH, Scheer Pelletizing Systems, Siemensstrasse 32, 70825 Korntal-Münchingen).

Melt Blends B, C, D, and E were also prepared. The compositions of the blends are set forth in Table 3. For each blend, the two polymers were fed to the throat of the Bertstorff ZE40A twin screw extruder (Berstorff GmbH Postfach 61 03 60D-30625 Hannover) via a Bonnot feeder (The Bonnot Company, 1301 Home Avenue, Akron, Ohio 44310) for the ethylene copolymers (ECP-1 and ECP-2) and via a Ktron K2G modular gravimetric loss in weight feeder (Coperion K-Tron, 590 Woodbury-Glassboro Road, Sewell, N.J. 08080 USA) for the ionomer. The twin screw extruder was fitted with a Gala MAP6 underwater pelletizer. The extruder screw profile was selected to provide good shear mixing. The extruder operate conditions for blend B are summarized in the table above. Other than the feed rates, the operate conditions for blends C, D and E were essentially the same as those described above for blend B.

TABLE 3
Blend Compositions

| | Ethylene | ECP | ECP | Ionomer | Ionomer |
|---|---|---|---|---|---|
| Ex. | Copolymer | content | feed rate | content | feed rate |
| No. | (ECP) | wt % | g/min | wt % | g/min |
| B | ECP-1 | 20.0% | 240 | 80.0% | 960 |
| C | ECP-1 | 33.0% | 496 | 67.0% | 804 |
| D | ECP-2 | 10.0% | 240 | 90.0% | 966 |
| E | ECP-2 | 33.0% | 496 | 67.0% | 804 |

Dispersions of the polymer blends were prepared according to the following procedure. The amount of each component in the blends is set forth in Table 4, below. Table 4 also includes the melt index in gm/10 min, measured on the pellets collected from each melt blend as per ASTM D1238 (190° C., 2.16 kgload). The equipment used was:
1. Pyrex Griffin beaker (800 ml) supplied by Sigma Aldrich Canada
2. DATAPLATE® Digital Hot Plate model PMC 730 hotplate (Barnstead|Thermolyne, 2555 Kerper Blvd. Dubuque, Iowa 52004-2241)
3. Six-bladed mixing head driven by a Calframo BDC2002 (Caframo Limited 501273 Grey Road 1, Georgian Bluffs ON NOH 2T0, Canada) stirrer.

Deionized water and polymer pellets were added to the beaker at ambient temperature. The beaker was placed on the hot plate, and the 6-bladed stirrer was positioned in the center of the beaker with the blades just above the bottom of the beaker. The top of the beaker was covered with foil to minimize evaporation. The water and pellets were heated with stirring (300 rpms) until the temperature of the water reached 90 to 95° C. The hot plate settings were adjusted periodically as necessary to maintain the water temperature in this range, and to avoid boiling the water during dispersion preparation. After 20 to 30 minutes of stirring and heating, a milky white dispersion formed. To verify the quality of the dispersion, it was poured through an 80 mesh stainless steel filter.

TABLE 4
Dispersion Compositions

| | | | | | | | | Nominal | |
|---|---|---|---|---|---|---|---|---|---|
| | Deionized | Blend A | Blend B | Blend C | Blend D | Blend E | Blend F | solids | |
| Ex. | Water | MI 0.51 | MI 4.6 | MI 2.4 | MI 8.6 | MI 6.9 | MI 1.79 | content | |
| No. | (gms) | (gms) | (gms) | (gms) | (gms) | (gms) | (gms) | wt % | Dispersed |
| 1 | 410 | 112 | | | | | | 21% | No |
| 2 | 450 | 50 | | | | | | 10% | No |
| 3 | 450 | | 50 | | | | | 10% | Yes |
| 4 | 450 | | | 50 | | | | 10% | Yes |
| 5 | 450 | | | | 50 | | | 10% | Yes |
| 6 | 450 | | | | | 50 | | 10% | Yes |
| 7 | 270 | | | | | | 30 | 10% | Yes |

The dispersions of Example Nos. 1 and 2, prepared with blend A, did not disperse at the 21% or 10 wt % solids loading. Blend A was re-extruded in this case using a ZSK-25 (25 mm diameter, 37/1 L/D) Krupp Werner & Pfleiderer (now Coperion) Extruder 25 mm with additional ionomer to make melt Blend F. Blend F was comprised of 60 wt % of Blend A and 40 wt % of ionomer (3 kg of Blend A and 2 kg of ionomer). The pellets were tumbled in a bag for 60 seconds and then fed into the throat of the extruder using a K-tron loss in weight feeder. The nominal loading of ECP-3 in Blend F was 20 wt %. Blend F and water produced a hot water dispersion.

### Formation of Fiber Cement Composition Using Aqueous Dispersion

### Composition Ranges of Fiber Cement Board (Dry Weight):

| | |
|---|---|
| Cement | 35-45% |
| Silica | 40-50% |
| Wood pulp | 5-15% |
| Additives | 0-2% |
| Polymer Blend Compn. | 0-5% |

Note:
Comparative Example (Unmodified Mixture) includes no polymer blend composition; Examples of the invention (Modified Mixtures) include a polymer blend composition.

### Unmodified Mixture

Silica sand is finely ground and mixed with water to form a silica slurry. Wood pulp is mixed with water to form a wood pulp slurry. Silica and wood pulp slurries are mixed with cement and additives to form a fiber cement slurry.

### Modified Mixture

A dispersion selected from those described in Table 4 is used as is or diluted in water to obtain desired % solids. This blend is mixed with silica sand that has been finely ground to form a modified silica slurry. The modified silica slurry is then mixed with a wood pulp slurry, cement and additives to form a fiber cement slurry modified with dispersion. Alternatively, the dispersion blend can be added to wood pulp and additional water as needed to form a modified wood pulp slurry. The modified wood pulp slurry is then mixed with a silica slurry, cement and additives to form a fiber cement slurry modified with dispersion.

### Board Manufacturing

The unmodified or dispersion-modified fiber cement slurry is de-watered in a sieve or a series of sieves, and the remaining mixture is laid on or picked up by a fine mesh. Residual water is drained through the mesh and a fiber cement sheet is formed. Vacuum can be used optionally to further reduce moisture in the sheet. A series of sheets are then collected together and squeezed with a roller or via other forms of pressure to create a fiber cement board. The fiber cement board is toughened up in highly pressurized oven (autoclave) to enhance chemical reaction and help cure the fiber cement board.

### Testing

The resulting fiber cement board s tested for water resistance, freeze-thaw resistance, flexural strength, tensile strength, elongation, impact and/or additional physical and chemical resistance tests. One or more of these tests are expected to show improved performance versus unmodified fiber cement board.

While certain of the preferred embodiments of this invention have been described and specifically exemplified above, it is not intended that the invention be limited to such embodiments. Various modifications may be made without departing from the scope and spirit of the invention, as set forth in the following claims.

1. A method for producing a polymer-modified fiber-cement composite comprising:
forming an aqueous composition by admixing an aqueous dispersion, cement, cellulosic fibers, siliceous material, and water; forming a composite precursor by removal of at least a portion of the water from the aqueous composition; and curing/drying the composite precursor to form the polymer-modified fiber-cement composite;
wherein the aqueous dispersion comprises a polymer blend composition, said polymer blend composition comprising or produced from:
(a) about 60 to about 99.9 weight % based on the total weight of (a) and (b), of an ionomer composition comprising or consisting essentially of an ionomer that is a neutralized product of a parent acid copolymer, wherein the parent acid copolymer comprises about 18 to about 30 weight % of copolymerized units of acrylic acid or methacrylic acid, based on the total weight of the parent acid copolymer, and a complementary amount of copolymerized units of ethylene; the parent acid copolymer having a melt flow rate (MFR) from about 200 to about 1000 g/10 min, measured according to ASTM D1238 at 190° C. with a 2160 g load, wherein about 50% to about 70% of the carboxylic acid groups of the copolymer, based on the total carboxylic acid content of the parent acid copolymer as calculated for the non-neutralized parent acid copolymer, are neutralized to form the ionomer, said ionomer comprising copolymerized carboxylic acid salts of potassium cations, sodium cations, or both potassium cations and sodium cations; and
(b) about 0.1 to about 40 weight %, based on the total weight of (a) and (b), of one or more ethylene copolymers selected from the group consisting of (i) an ethylene elastomer comprising copolymerized units of ethylene, about 45 to about 80 weight % of copolymerized units of at least one alpha,beta-ethylenically unsaturated carboxylic acid ester and optionally about 0.5 to about 10 weight % of copolymerized units of 2-butene-2,4-dioic acid or its derivative, wherein the derivative is an anhydride of the acid or a monoalkyl ester of the acid, wherein the weight percentages are complementary and based on the total weight of the ethylene elastomer; (ii) ethylene dicarboxyl copolymer comprising copolymerized units of ethylene and copolymerized units of a dicarboxyl comonomer comprising an anhydride group, a vicinal pair of carboxylic groups and a carboxylic group adjacent to an alkoxycarbonyl group; (iii) at least one ethylene ester copolymer comprising copolymerized units of ethylene and about 10 to about 45 weight % of copolymerized units of an alpha, beta-ethylenically unsaturated carboxylic acid ester, based on the total weight of the ethylene ester copolymer; and (iv) a grafted polyolefin composition comprising a parent polyolefin grafted with about 0.1 to about 5 weight % of an alpha,beta-ethylenically unsaturated carboxylic acid or anhydride, based on the total weight of the grafted polyolefin.

2. The method of claim 1, wherein the ethylene copolymer comprises the ethylene elastomer.

3. The method of claim 1, wherein the ethylene copolymer comprises the ethylene dicarboxyl copolymer.

4. The method of claim 1, wherein the ethylene copolymer comprises the ethylene ester copolymer.

5. The method of claim 1, wherein the ethylene copolymer comprises the grafted polyolefin.

6. The method of claim 1, wherein the blend composition comprises about 75 to about 99.9 weight % of the ionomer composition and about 0.1 to about 25 weight % of the one or more ethylene copolymers.

7. The method of claim 1, wherein the polymer-modified fiber-cement composite comprises from 0.1% to 15 wt % of the polymer blend composition by weight, based on the total weight of the polymer-modified fiber-cement composite after drying.

8. A polymer-modified fiber-cement composite comprising cement, cellulosic fibers, siliceous material, and a polymer blend composition, said polymer blend composition comprising or produced from:
(a) about 60 to about 99.9 weight % based on the total weight of (a) and (b), of an ionomer composition comprising or consisting essentially of an ionomer that is a neutralized product of a parent acid copolymer, wherein the parent acid copolymer comprises about 18 to about 30 weight % of copolymerized units of acrylic acid or methacrylic acid, based on the total weight of the parent acid copolymer, and a complementary amount of copolymerized units of ethylene; the parent acid copolymer having a melt flow rate (MFR) from about 200 to about 1000 g/10 min, measured according to ASTM D1238 at 190° C. with a 2160 g load, wherein about 50% to about 70% of the carboxylic acid groups of the copolymer, based on the total carboxylic acid content of the parent acid copolymer as calculated for the non-neutralized parent acid copolymer, are neutralized to form the ionomer, said ionomer comprising copolymerized carboxylic acid salts of potassium cations, sodium cations, or both potassium cations and sodium cations; and
(b) about 0.1 to about 40 weight %, based on the total weight of (a) and (b), of one or more ethylene copolymers selected from the group consisting of (i) an ethylene elastomer comprising copolymerized units of ethylene, about 45 to about 80 weight % of copolymerized units of at least one alpha,beta-ethylenically unsaturated carboxylic acid ester and optionally about 0.5 to about 10 weight % of copolymerized units of 2-butene-2,4-dioic acid or its derivative, wherein the derivative is an anhydride of the acid or a monoalkyl ester of the acid, wherein the weight percentages are complementary and based on the total weight of the ethylene elastomer; (ii) ethylene dicarboxyl copolymer comprising copolymerized units of ethylene and copolymerized units of a dicarboxyl comonomer comprising an anhydride group, a vicinal pair of carboxylic groups and a carboxylic group adjacent to an alkoxycarbonyl group; (iii) at least one ethylene ester copolymer comprising copolymerized units of ethylene and about 10 to about 45 weight % of copolymerized units of an alpha, beta-ethylenically unsaturated carboxylic acid ester, based on the total weight of the ethylene ester copolymer; and (iv) a grafted polyolefin composition comprising a parent polyolefin grafted with about 0.1 to about 5 weight % of an alpha,beta-ethylenically unsaturated carboxylic acid or anhydride, based on the total weight of the grafted polyolefin.

9. The polymer-modified fiber-cement composite of claim 8, wherein the ethylene copolymer comprises the ethylene elastomer.

10. The polymer-modified fiber-cement composite of claim 8, wherein the ethylene copolymer comprises the ethylene dicarboxyl copolymer.

11. The polymer-modified fiber-cement composite of claim 8, wherein the ethylene copolymer comprises the ethylene ester copolymer.

12. The polymer-modified fiber-cement composite of claim 8, wherein the ethylene copolymer comprises the grafted polyolefin.

13. The polymer-modified fiber-cement composite of claim 8, wherein the polymer blend composition comprises about 75 to about 99.9 weight % of the ionomer composition and about 0.1 to about 25 weight % of the ethylene copolymer.

14. The polymer-modified fiber-cement composite of claim 8, comprising from 0.1% to 15% of the polymer blend composition by weight, based on the total weight of the polymer-modified fiber-cement composite after drying.

15. An article comprising the polymer-modified fiber-cement composite of claim 8.

16. The article of claim 15, wherein the polymer blend composition is applied as a coating on a fiber cement substrate.

17. The article of claim 16, wherein the polymer blend composition comprises about 75 to about 99.9 weight % of the ionomer composition and about 0.1 to about 25 weight % of the ethylene copolymer.
